(19) United States
(12) Patent Application Publication
(10) Pub. No.: US 2022/0314507 A1
(43) Pub. Date: Oct. 6, 2022

(54) MULTI-COMPONENT INJECTION MOULDING MACHINE

(71) Applicant: Ferromatik Milacron GmbH, Teningen (DE)

(72) Inventors: Rolf ZIPSE, Emmendingen (DE); Klaus KRATT, Emmendingen (DE); Etienne BERGMANN, Malterdingen (DE)

(21) Appl. No.: 17/846,844

(22) Filed: Jun. 22, 2022

Related U.S. Application Data
(63) Continuation of application No. PCT/EP2020/086203, filed on Dec. 15, 2020.

(30) Foreign Application Priority Data
Dec. 23, 2019 (DE) 10 2019 135 731.4
Jan. 24, 2020 (DE) 10 2020 101 748.0

(51) Int. Cl. B29C 45/17; B29C 45/07; B29C 45/16; B29C 45/50

(52) U.S. Cl. CPC B29C 45/1775; B29C 45/07; B29C 45/1603; B29C 45/5008; B29C 2045/1685; B29C 2045/5028; B29C 2045/506

(57) ABSTRACT

A multi-component injection moulding machine provided has a machine bed, two mould mounting plates movable relative to one another by a closing unit, an injection unit and an extruder unit. The injection unit moves relative to the neighbouring mould mounting plate and has a nozzle having a nozzle head. The extruder unit is adjustable between a first position, where a nozzle contact of the extruder unit rests on the nozzle head, and a second position releasing the injection unit for contacting of the nozzle head on a tool mounted on the neighbouring mould mounting plate. In the first position, the extruder unit and the injection unit can be directly coupled, and the extruder unit has a coupling unit having a second clamping element cooperating mechanically with a clamping element on the injection unit such that the coupling device provides a pressing force of the nozzle head on the nozzle contact.

### CROSS REFERENCE TO RELATED APPLICATIONS

This application is a continuation under 35 U.S.C. § 120 of International Application PCT/EP2020/086203, filed Dec. 15, 2020, which claims priority to German Applications Nos. 10 2019 135 731.4, filed Dec. 23, 2019 and 10 2020 101 748.0, filed Jan. 24, 2020, the contents of each of which are incorporated by reference herein.

### FIELD OF THE INVENTION

The present invention relates to a multi-component injection moulding machine, comprising a machine bed, at least two mould clamping plates that can be moved relative to one another using a clamping unit, an injection unit and an extruder unit, whereby the injection unit can be moved relative to the adjacent mould clamping plate and comprising a nozzle with a nozzle head and the extruder unit can be adjusted between a first position, in which a nozzle support of the extruder unit rests against the nozzle head, and a second position releasing the injection unit for possible contact of its nozzle head on a tool clamped on the adjacent mould clamping plates.

### BACKGROUND

Multi-component injection moulding machines allow the production of plastic articles that consist of several components and have a multi-layer cross-section. Due to this multi-layer nature of the plastic article, the corresponding manufacturing process is also known as a sandwich injection moulding process. Such multi-component plastic articles are typically characterized in that the outer skin structure is formed from a different component than their inner core structure. Thanks to a skilful selection of the components for the skin structure (skin component) and the core structure (core component), different material properties of the various components can be used to provide a plastic article having properties that are superior to those of a one-component plastic article. In particular, when the use of a relatively expensive component on the surface of a plastic article is indicated, but in the core of which a cheaper component can be used, the multi-component plastic article is characterized by a cost advantage. Against the background of the growing significance of recycling of plastics, especially recycled plastics, the so-called recyclate can be used as components for the core structure without negatively affecting the properties of the surface of the plastic article.

The multilayered cross-section of the plastic article is achieved, in which the two components present as melt are conveyed directly one after the other during an injection process into an injection mould arranged between the two mould mounting plates. The injected melt begins to solidify immediately upon contact with the walls of the injection mould, so that the melt in the middle of the flow advances faster than the melt in the vicinity of the walls. Accordingly, the melt that is introduced into the injection mould at the beginning of the injection process would form the skin structure, while the melt that follows later forms the core structure.

In mono-sandwich injection moulding machines, the various components present in the form of a melt are injected into the injection mould in the course of a single injection process of a single injection unit, whereby the melt of the various components is layered in the injection unit in such a way that the components are conveyed into the injection mould one after the other during the injection process.

The layered arrangement of the two components in the injection unit is achieved such that the injection unit is provided with the molten skin component via its nozzle from the extruder unit, while the core component is supplied by a plasticizing and injection screw of the injection unit. The skin component and the core component are thus—before the respective “shot”—placed directly adjacent to one another and thus layered one behind the other in the injection unit, whereby the skin component is arranged directly in the region of the nozzle.

Generic multi-component injection moulding machines have been known for many years and have proven themselves in practice. EP 0692359 A1 describes, for example, a device for injection moulding using the mono-sandwich method, in which an additional plasticizing unit can be connected to or detached from the main injection unit. If the plasticizing unit and main injection unit are interconnected, skin material can be conveyed from the plasticizing unit into a cylinder (screw ante-chamber) of the main injection unit. The injection unit carries out the plasticization of the core material so as to complete the layered arrangement of skin and core material necessary for the sandwich injection process. The main injection unit is then detached from the plasticizing unit and moved into position for injection into the mould.

### SUMMARY

The present invention has the task of providing an even further improved multi-component injection moulding machine, in particular with regard to practical suitability and economy as well as with regard to the possibility of retrofitting one-component injection moulding machines to multi-component injection moulding machines.

This object may be achieved by an injection moulding machine of the generic type, in which in the first position the extruder unit and the injection unit can be coupled directly to each other by means of a coupling device, in that the extruder unit comprises a coupling unit which mechanically interlocks with at least one first clamping element provided on the injection unit comprising cooperating second clamping element that the coupling device provides a contact pressure of the nozzle head on the nozzle support. In other words, the mechanical interlocking of the first clamping element with the second clamping element ensures that a pressing force of the nozzle head is exerted on the nozzle support and, as a result, the injection unit and the extruder unit are coupled (clamped) to each other.

The locking of the injection unit with the extruder unit is characterized by the fact that between these two units not only the contact pressure (between the nozzle head and the nozzle support) but also an essentially opposing clamping force acts between the clamping elements. Since—in the sense of a direct short frictional connection—the contact force and the clamping force in their effect on the extruder unit cancel each other (at least substantially), there are hardly any forces that have to be supported on the extruder unit in the direction of the contact force. This represents a fundamental departure from the solution established in the prior art, in which the contact pressure between the nozzle head and nozzle support is applied by pressing or tensioning the injection unit against the extruder unit by means of an injection unit actuator and accordingly supporting the extruder unit with correspondingly massive amounts. Against this background, the extruder unit in a known injection moulding machine of the generic type is typically supported on the mould clamping plate adjacent to the extruder unit, as this can typically withstand the forces caused by the support, on a permanently basis.

Therefore, the fact that the extruder unit of the said injection moulding machine has to support significantly fewer forces in the contact force direction than in the prior art enables a number of surprising advantages.

On the one hand, the cycle time can be reduced and thus, the economic efficiency can be improved, since the support of the extruder unit and the extruder unit itself can be made less massive and thus lighter, and the associated reduction in the moving mass enables higher movement speeds of the extruder unit. Further, a lighter design of the extruder unit and its support has the advantage of saving material, which has an equally positive effect on the production costs and also the economy.

On the other hand, new possibilities and degrees of freedom are opened up in the arrangement and connection of the extruder unit to the rest of the multi-component injection moulding machine, since—due to the elimination of the need to apply the counterforce of the contact pressure to the extruder unit by supporting the extruder unit—the extruder unit need not (as is usual in the prior art) be supported on a mould clamping plate. It enables a connection of the extruder unit via a holding structure which, for example, is directly connected to the machine bed or the injection unit.

This expansion of the options for connecting the extruder unit to the rest of the multi-component injection moulding machine enables one-component injection moulding machines to be upgraded to multi-component injection moulding machines, even if conventional support to the extruder unit on a mould clamping plate (as is common in the prior art) is not possible, because of the available space or the force absorption capacity of the injection moulding machine to be retrofitted. In this way, more one-component injection moulding machines are suitable for subsequent upgrading, which has an advantageous effect on the applicability and thus the economic significance of this disclosure.

The coupling unit preferably comprises an extruder channel opening into the nozzle support and the nozzle head has a nozzle opening, whereby when the extruder unit is coupled to the injection unit by means of the coupling device, the nozzle opening and the mouth of the extruder channel in the nozzle support overlap each other and the nozzle head rests fluid-tight on the nozzle support. This makes it possible, in a simple and reliable manner, for the plastic melt of the skin material to be conveyed from the extruder unit into the injection unit, when the extruder unit and the injection unit are properly coupled so as to achieve the layered arrangement of skin material and core material in the injection unit.

In a particularly preferred manner, a closure element is arranged in the extruder channel. The closure element is able to automatically release or close the extruder channel in a pressure-controlled or externally controlled manner. In this way, it can be made possible that—if the extruder unit and the injection unit are not coupled—no plastic melt residues drip out of the channel of the extruder unit and the associated contamination and functional impairments are prevented. In the case of closure element being closed, it can also be prevented that plastic melt in the extruder channel is in direct contact with relatively cold air and that a plastic skin is formed on this contact surface, which would hinder the subsequent conveyance of plastic melt through the extruder channel.

Another preferred development of the invention is characterized in that the position of at least one first clamping element can be changed relative to the nozzle head and/or that the position of at least one second clamping element can be changed relative to the nozzle support. By changing the position of the first clamping element (and/or the second clamping element) relative to the nozzle head (or to the nozzle support), the mechanical interlocking of the first clamping element with the second clamping element can be brought about or prevented.

In a preferred manner, the change in the position of at least one first clamping element relative to the nozzle head and/or the change in the position of at least one second clamping element vis-à-vis the nozzle support can be brought about by means of at least one clamping actuator. By actuating the clamping actuator, the engagement of the first clamping element with the second clamping element can be effected or prevented in a targeted manner, and detached from a relative movement between the rest of the extruder unit and the rest of the injection unit; thus thrust forces can occur on the clamping elements and the nozzle and the nozzle support can be largely prevented.

At least one clamping spring acts particularly advantageously on at least one first clamping element and/or at least one second clamping element. Preferably, a spring force emanating from the clamping spring causes the first clamping element to mechanically interlock with the second clamping element, which engages with the nozzle head and the nozzle support and as a result, the extruder unit and the injection unit are coupled directly to each other. Therefore, the clamping actuator counteracting the spring force only has to be actuated when the mechanical interlocking of the first clamping element with the second clamping element is to be prevented, i.e., the extruder unit and the injection unit are to be decoupled and moved out of the first position. Thanks to this skilful interaction of the clamping spring and the clamping actuator, relatively less energy is required for actuating the clamping actuator, which benefits the energy efficiency of the said injection moulding machine.

The mechanical interlocking of the first clamping element with the second clamping element is alternatively effected by the clamping actuators instead of the clamping springs.

Depending on the specific installation situation and the demands of the forces to be applied, the clamping actuator is preferably designed as a linear actuator or comprises an eccentric or a toggle lever.

Another preferred development of the said multi-component injection moulding machine is characterized in that the movement of the extruder unit into the first position causes at least one first clamping element to interlock with at least one second clamping element and the extruder unit and couple the injection unit directly to each other by means of the coupling device couple and the coupling device provides the contact pressure of the nozzle head on the nozzle support. In other words, the interlocking of the first clamping element with the second clamping element and the associated exertion of the contact pressure between the nozzle support and the nozzle head is brought about solely by moving the extruder unit and the injection unit into the first position, so that a separate clamping actuator as per the above design can be dispensed with and an injection moulding machine, which is particularly simple in design and easy to control, can be implemented.

According to a further preferred development, at least one first clamping element and/or at least one second clamping element is wedge-shaped. In particular, (but not exclusively) in the said injection moulding machines, in which the first clamping element engages with the second clamping element only by moving the extruder unit and the injection unit into the first position, thanks to the wedge-shaped design of the first clamping element and/or the second clamping element, a particularly simple clamping device can be realized.

Instead of moving the entire extruder unit—according to a further preferred development of the invention—the extruder unit can be moved into the first position in that the coupling unit can be moved relative to the rest of the extruder unit by means of a coupling unit drive. In other words, this enables the extruder unit to be moved into the first position only by moving the coupling unit while the rest of the extruder unit does not experience any movement. In this way, the moving mass can be reduced even further, which enables a further preferred reduction in the cycle time.

This is made possible in a particularly preferred manner in that the coupling unit is swivel-mounted on the rest of the extruder unit. In this way, the described movement of the coupling unit, which is independent of the rest of the extruder unit, can be designed particularly simply, inexpensively and with very small moving masses.

Another preferred development of the said multi-component injection machine is characterized in that the extruder unit comprises an extruder housing, a swivelling extruder screw accommodated in the extruder housing, and a drive unit driving the extruder screw, whereby the extruder housing means of an extruder actuator can be moved.

Depending on specific installation situation and the requirements placed on the drive unit and the extruder actuator, the drive unit is preferably designed as an electromotive, hydraulic or pneumatic drive unit and/or the extruder actuator is configured as an electromotive, hydraulic or pneumatic extruder actuator.

In particular with regard to the subsequent upgrading of a one-component injection moulding machine to the said multi-component injection moulding machine, it can be particularly preferred that the extruder unit comprises a hydraulic or pneumatic unit, by means of which the hydraulic or pneumatic drive unit and/or the hydraulic or pneumatic extruder actuator can be provided with pressurized liquid medium. Since the extruder unit itself thus includes the unit required to drive the drive unit and the extruder actuator, the extruder actuator and the drive unit do not have to be connected to a corresponding external unit, which means that the control and energy-related connection of the extruder unit to the rest of the injection moulding machine is facilitated.

Alternatively, in some installation situations—especially if the said multi-component injection moulding machine is to be designed by completely rebuilding and not by subsequently upgrading a one-component injection moulding machine—it can be advantageous if the hydraulic or pneumatic extruder actuator and/or the hydro-motor or pneumatic drive unit can be provided with pressurized fluid medium from a hydraulic or pneumatic unit, which is not part of the extruder unit. In this way, it can be made possible that one and the same unit not only supplies the drive unit and the extruder actuator with fluid medium, but also any other consumers, such as the clamping unit, whereby the complexity and the manufacturing costs of the injection moulding machine can be reduced.

In view of specific limitations of installation space, it can be advantageous if the extruder housing and the injection unit housing can be arranged in different positions relative to each other. A large number of different arrangement constellations are possible within the scope of the invention. The extruder housing and the injection unit housing are preferably configured in a cylindrical design. In the first position, the longitudinal axis of the cylindrical extruder housing and the longitudinal axis of the cylindrical injection unit housing preferably span a vertical or horizontal plane and enclose an angle of 90° or less.

A further preferred development of the invention is characterized in that the extruder unit is mechanically connected to the rest of the multi-component injection moulding machine via a mechanical interface and this is designed as Euro map interface, in particular in accordance with EM18 or VDMA24466. By using the standardized Euro map interface, the mechanical connection of the extruder unit to the rest of the multi-component injection moulding machine can also be implemented very easily across manufacturers, which is particularly advantageous with a view to retrofitting single-component injection moulding machines.

According to a further preferred development, the extruder unit communicates with the rest of the multi-component injection moulding machine via a signal interface. The signalling interface is apt for transmitting at least three signals, whereby a first signal indicates that the injection unit lies in a position corresponding to the first position of the extruder unit, wherein a second signal points to the fact that the extruder unit is in the second position and whereby a third signal indicates that the extruder unit and the injection unit are both in the first position and are coupled to each other and that the drive unit of the extruder unit drives the extruder screw. The three signals are sufficient to control and coordinate the successful interaction of the extruder unit and injection unit during the entire multi-component injection moulding process. Because, according to embodiments of the invention, only three signals are required for this, the effort that arises from the signal-technical coupling of the extruder unit with the rest of the multi-component injection moulding machine can be reduced to a necessary minimum, which would result in low costs and especially when upgrading one-component injection moulding machines reduce the complexity in a preferred manner.

### BRIEF DESCRIPTION OF THE DRAWING

Two exemplary embodiments of the said multi-component injection moulding machine are explained in more detail below with reference to the drawing, as follows:

FIG. 1 shows an extruder unit, an injection unit and a mould mounting plate of a first embodiment in the first position in a side view,

FIG. 2 shows the injection moulding machine parts according to FIG. 1 in the second position in a side view,

FIG. 3a shows an enlarged detail from FIG. 1 in a vertical section,

FIG. 3b shows the enlarged detail according to FIG. 3a in an oblique perspective oblique view and

FIG. 3c shows the oblique perspective view from FIG. 3b in a partial sectional view

FIG. 4 shows a partially schematic section of an extruder unit and an injection unit of a second exemplary embodiment of the said multi-component injection moulding machine in the first position in a vertical section,

FIG. 5 shows the first clamping element according to FIG. 4 in vertical section and front view,

FIG. 6 shows the second clamping element according to FIG. 4, also in vertical section and front view and

FIG. 7 shows a specific embodiment of the second exemplary embodiment, shown partially schematically in FIGS. 4 to 6, in the first position in a vertical section, and

FIG. 8 illustrates in a schematic overall view an injection moulding machine designed to implement embodiments of the present invention.

### DETAILED DESCRIPTION OF THE PREFERRED EMBODIMENTS

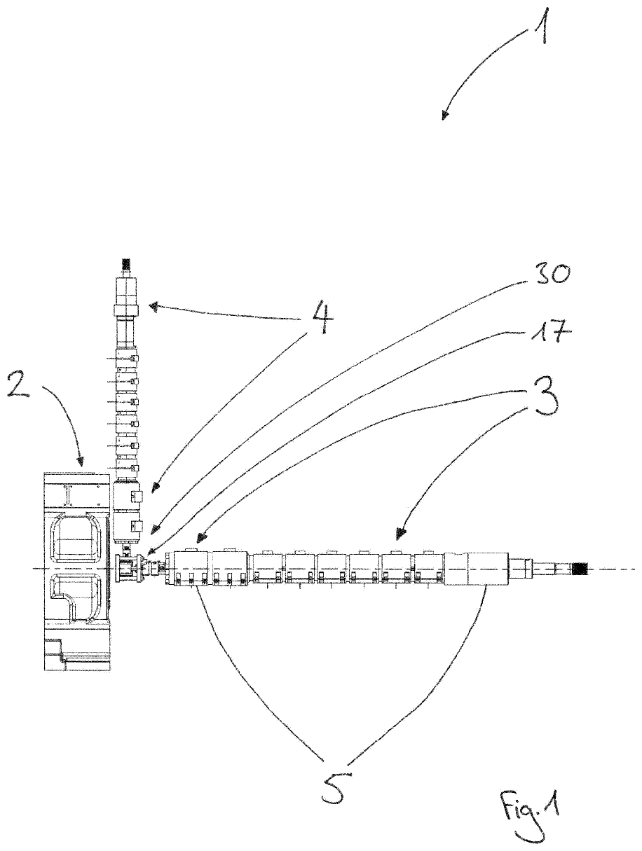

FIG. 1 to 3c only shows selected injection moulding machine parts and the interaction of a first exemplary embodiment of the said multi-component injection moulding machine 1. The multi-component injection moulding machine 1 comprises—in the usual way—a machine bed, two mould mounting plates 2 that can be moved about relative to one another by means of a clamping unit, an injection unit 3 and an extruder unit 4, the machine bed, the clamping unit and one of the two mould mounting plates that are not shown for the sake of clarity.

The injection unit 3 can be horizontally moved relative to the adjacent mould clamping plate 2 and comprises an injection unit housing 5 of cylindrical design; a swivelling, plasticizing and injection screw 6 accommodated in the injection unit housing 5 and can be displaced along its axis, and a nozzle 7. The nozzle 7 has a conical nozzle head 8, a cylindrical nozzle body 9 and a collar 10 formed at the transition between nozzle head 8 and nozzle body 9, whereby the first clamping element 11 is formed via the collar 10 and nozzle head 8 has a nozzle opening 12. The injection unit 3 also has an injection channel 13, in which a first closure element 14 is foreseen.

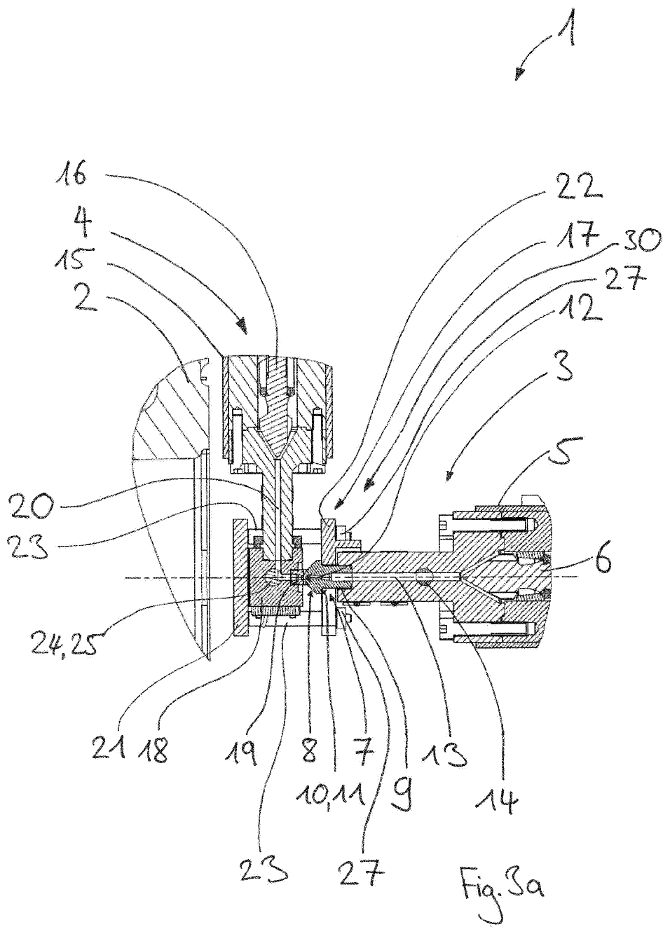

The extruder unit 4 comprises a cylindrical extruder housing 15, a swivelling extruder screw 16 accommodated in the extruder housing 15, a drive unit (not shown) that drives the extruder screw 16, and an extruder actuator (not shown), by means of which the extruder housing 15 can be moved vertically relative to the mould mounting plate 2 is. In addition, the extruder unit 4 has a coupling unit 17. The coupling unit 17 comprises a deflection head 18, a nozzle support 19 opening into an extruder channel 20, a support plate 21 firmly connected to the deflection head 18, a second clamping element 22 and four stud bolts 23 connecting the support plate 21 to the second clamping element 22, arranged parallel to one another in the region of a corner of the support plate 21, and are each perpendicular to the plane defined by the support plate 21. A second closure element 25, designed as a pivot pin 24, is foreseen in the extruder channel 20 (see FIG. 3a).

The second clamping element 22 is plate-shaped parallel to the support plate 21 and has a vertically running, downwardly open slot 26, which is so dimensioned that the cylindrical nozzle body 9 can be encompassed and thus the first clamping element 11, the collar 10 of the nozzle 7 can be engaged from behind by the second clamping element 22.

Four clamping springs 27 and two clamping actuators 29 designed as linear actuators 28 that counteract the clamping springs 27 can be used to act on the second clamping element 22 and change its position relative to the nozzle support 19 or to the support plate 21 by moving it along the axes of the stud bolts 23. As intended, the four clamping springs 27 exert a force on the second clamping element 22 in the direction of the support plate 21, while the two clamping actuators 29 are powerful enough to move the second clamping element 22 against the resistance of the clamping springs 27 in the opposite direction.

FIG. 1 and FIGS. 3a to 3c show the extruder unit 4 and the injection unit 3 in a first position, in which the nozzle support 19 of the extruder unit 4 rests against the nozzle head 8 of the injection unit 3. Using a coupling device 30, the extruder unit 4, which is in the first position, and the injection unit 3 can be coupled directly to each other. To this end, the first clamping element 11 interacts mechanically with the second clamping element 22 in such a way that the coupling device 30 provides a pressing force of the nozzle head 8 on the nozzle support 19 so that the nozzle head 8 rests fluid-tight on the nozzle support 19.

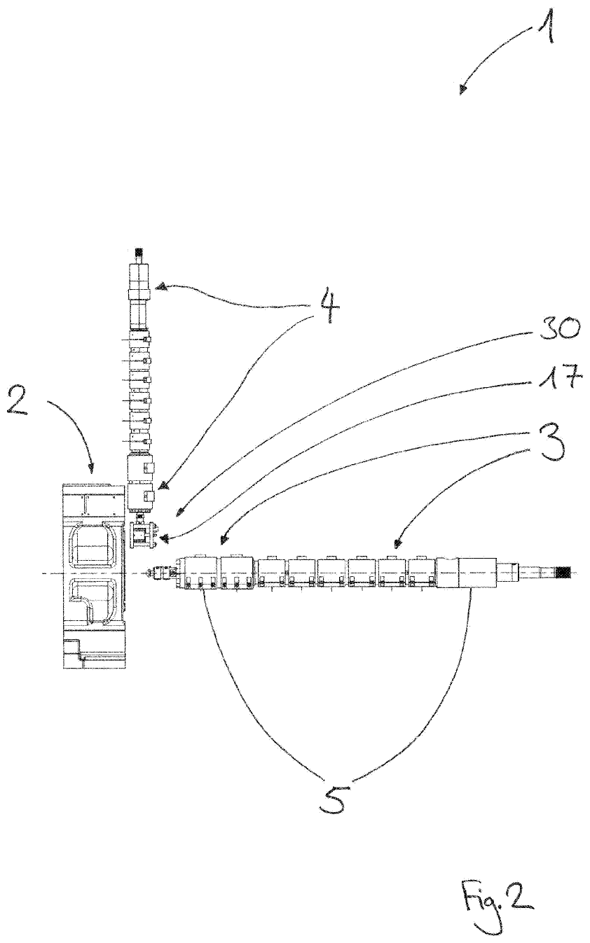

For this purpose, the second clamping element 22 first engages from behind the first clamping element 11, in which the extruder unit 4 is lowered vertically from the second position (see FIG. 2) into the first position by means of the extruder actuator (not shown), and indeed, when the extruder unit 4 actuates the clamping actuators 29. The two clamping actuators 29 are then deactivated and thus enable the four clamping springs 27 to force the second clamping element 22 in the direction of the support plate 21. Thus, the second clamping element 22 and the first clamping element 11 engage mechanically and bring about the pressing force between the nozzle support 19 and the nozzle head 8, as a result of which the injection unit 3 and the extruder unit 4 are coupled (clamped) to each other.

Plastic melt of a skin component can then be conveyed from the extruder unit 4 via the extruder channel 20 via the nozzle 7 into the injection unit 3.

In order to release the coupling of the extruder unit 4 with the injection unit 3 (after the plastic melt has been conveyed into the injection unit 3), the two clamping actuators 29 must be actuated and the second clamping element 22 must be moved against the resistance of the clamping springs 27 so that interlocking of the first clamping element 11 with the second clamping element 22 is prevented. The extruder unit 4 can then be withdrawn vertically upwards by means of the extruder actuator (not shown) and moved into the second position. In the second position, the extruder unit 4 releases the injection unit 3 so that its nozzle head 8 can possibly rest against a tool clamped on the adjacent mould clamping plate 2 and thus, in other words, it enables the injection unit 3 to move in the direction of the adjacent mould clamping plate 2.

The longitudinal axis of the cylindrical extruder housing 15 and the longitudinal axis of the cylindrical injection unit housing 5 stretches a vertical plane and enclose an angle of 90°.

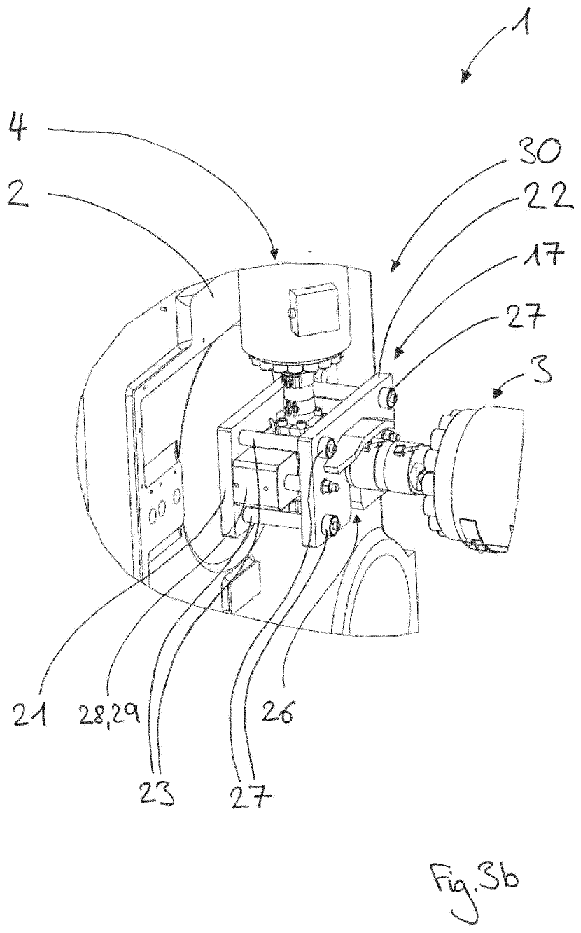

FIG. 4 shows partially schematically a second embodiment of the said multi-component injection moulding machine (1), but restricts the representation to the injection moulding machine parts that are directly integrated in the coupling process in a coupling device 30.

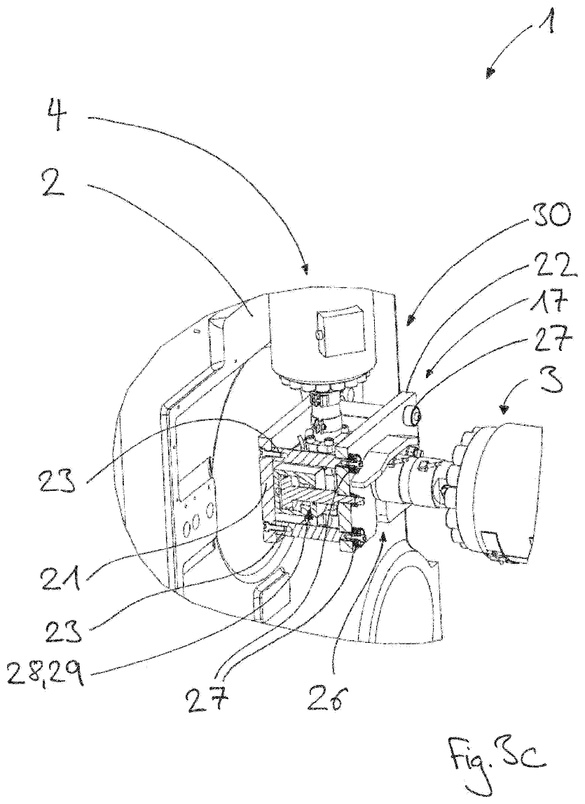

The injection unit 3, partially illustrated, can be moved horizontally and comprises an injection unit housing 5 and a nozzle 7 with a nozzle head 8 including nozzle opening 12 and a cylindrical nozzle body 9. Further, the injection unit 3 has a wedge-shaped first clamping element 11 firmly connected to the nozzle 7, which has an opening 31 through which the cylindrical nozzle body 9 stretches (see FIG. 5).

Likewise, the extruder unit 4, which is only partially shown, can be moved vertically and has an extruder housing 15 and a coupling unit 17. The coupling unit 17 comprises a deflection head 18, a nozzle support 19, into which an extruder channel 20 opens, a second clamping element 22 and four stud bolts 23 that rigidly connect the second clamping element 22 to the deflection head 18.

The second clamping element 22 is plate-shaped and has a vertically running, downwardly open slot 26, which is dimensioned such that the second clamping element 22 can grip around the cylindrical nozzle body 9 and thus engage the first clamping element 11 from behind. The stud bolts 23 are each arranged parallel to one another in the region of a corner of the second clamping element 22. With the vertical lowering of the extruder unit 4 into a first position (in which the nozzle support 19 rests against the nozzle head 8), the second clamping element 22 is also lowered to the same extent. Thus, the movement of the extruder unit 4 into the first position causes the first clamping element 11 to interact with the second clamping element 22 and to couple the extruder unit 4 and the injection unit 3 directly to one another by means of the coupling device 30 and thus the coupling device 30 provides the contact pressure of the nozzle head 8 on the nozzle support 19.

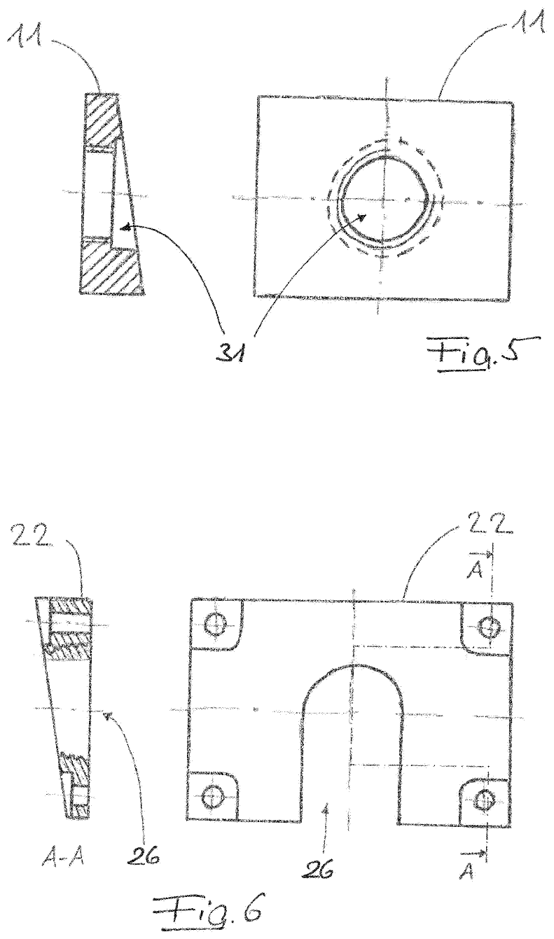

FIG. 7 shows, by way of example, a specific embodiment of the second exemplary embodiment, shown partially schematically in FIG. 4 to FIG. 6. To avoid repetition, only a few design details are explained in more detail below.

The stud bolts 23 are connected to the deflection head 18 through a pressure plate 21, which is firmly connected to both the stud bolts 23 and the deflection head 18. The second clamping element 22 comprises a clamping wedge 33 and a clamping plate 34 rigidly connected to it, the stud bolts 23 being rigidly connected to the clamping plate 34.

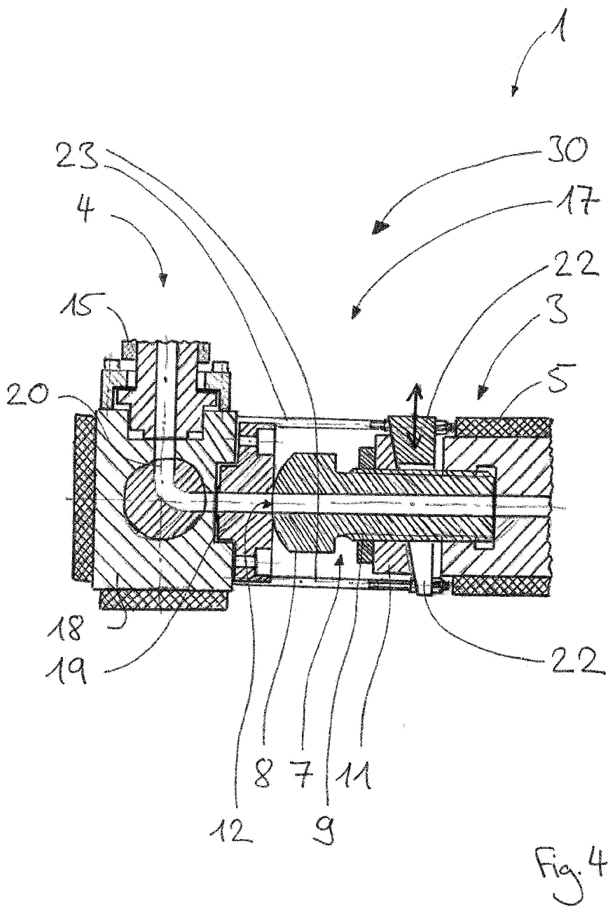

Alternatively, it would also be conceivable (although not shown in the drawing) that the clamping wedge 33 can be vertically moved with respect to the clamping plate 34 by means of a clamping actuator 29, while the clamping plate 34 is firmly connected to the stud bolts 23. In this way, the first clamping element 11 could engage with the second clamping element 22 independently of the movement of the extruder unit 4 into the first position. This could also be achieved with a one-piece second clamping element 22 (cf. FIGS. 4 and 6) if the second clamping element 22 is mounted on the extruder unit 4 in such a way that it can be moved vertically with respect to the deflection head 18, for example, by means of a clamp actuator 29.

In the first position, shown in FIG. 7, the first clamping element 11 and the clamping wedge 33 are in direct contact with each other. The axial position of the first clamping element 11 on the nozzle body 9 is secured by means of a lock nut 32. For this purpose, the lock nut 32 and the opening 31 of the first clamping element 11 each have an internal thread which corresponds to an external thread of the nozzle body 9. The injection unit 3 has a first closure element 14 provided in the injection channel 13. In the extruder channel 20, a second closure element 25 designed as a pivot pin 24 is provided.

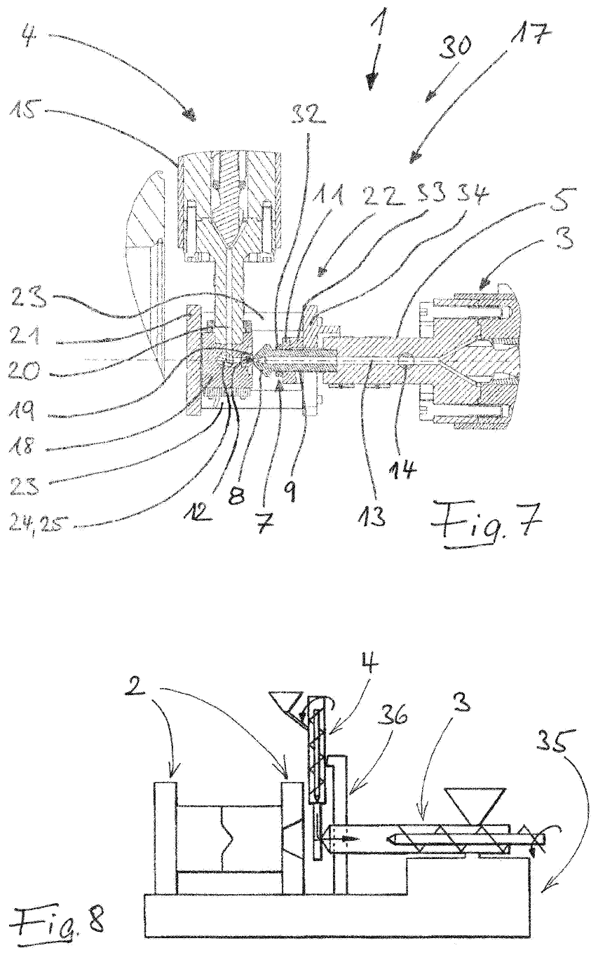

According to FIG. 8, which is based on EP 0 692 359 A1 (see above) forming the relevant prior art, an injection moulding machine 1 designed to implement embodiments of the present invention, as explained in detail above, has two mould mounting plates 2, an injection unit 3, an extruder unit 4 and a machine bed 35. The extruder unit 4 is firmly connected to the machine bed 35 via a holding structure 36.

What is claimed is:

1. A multi-component injection moulding machine (1), comprising a machine bed, at least two mould mounting plates (2) that can be moved relative to each other by means of a closing unit, an injection unit (3), and an extruder unit (4), wherein
the injection unit (3) can be moved relative to the adjacent plate (2) and comprises a nozzle (7) with a nozzle head (8), and the extruder unit (4) can be adjusted between a first position in which a nozzle support (19) of the extruder unit (4) is in contact with the nozzle head (8), and a second position in which the injection unit (3) is released for possible contact of its nozzle head (8) with a tool clamped on the adjacent mould mounting plate (2),
wherein the first position the extruder unit (4) and the injection unit (3) can be coupled directly to each other by means of a coupling device (30) in that the extruder unit (4) comprises a coupling unit (17) which has at least one second clamping element (22) cooperating, by mechanical interlock, with at least one first clamping element (11) provided on the injection unit (3), such that the coupling device (30) provides a pressing force of the nozzle head (8) on the nozzle support (19).

2. The multi-component injection moulding machine (1) of claim 1, wherein the coupling unit (17) comprises an extruder channel (20) opening into the nozzle support (19) and the nozzle head (8) has a nozzle opening (12), whereby with direct coupling of the extruder unit (4) and the injection unit (3) through the coupling device (17) the nozzle opening (12) and the mouth of the extruder channel (20) in the nozzle support (19) overlap each other and the nozzle head (8) is held fluid-tight at the nozzle support (19).

3. The multi-component injection moulding machine (1) of claim 2, wherein a closure element (25) is arranged in the extruder channel (20).

4. The multi-component injection moulding machine (1) of claim 1, wherein the position of at least one first clamping element (11) relative to the nozzle head (8) can be changed and/or that the position of at least one second clamping element (22) can be changed relative to the nozzle support (19).

5. The multi-component injection moulding machine (1) of claim 4, wherein the change in the position of at least one first clamping element (11) vis-à-vis the nozzle head (8) and/or the change in the position of at least one second clamping element (22) relative to the nozzle support (19) can be brought about by means of at least one clamping actuator (29).

6. The multi-component injection moulding machine (1) of claim 5, wherein at least one clamping spring (27) acts on at least one first clamping element (11) and/or at least one second clamping element (22).

7. The multi-component injection moulding machine (1) of claim 5, wherein at least one clamping actuator (29) is designed as a linear actuator (28).

8. The multi-component injection moulding machine (1) of claim 5, wherein at least one clamping actuator (29) comprises an eccentric.

9. The multi-component injection moulding machine (1) of claim 5, wherein at least one clamping actuator (29) comprises a toggle lever.

10. The multi-component injection moulding machine (1) of claim 1, wherein the movement of the extruder unit (4) into the first position causes the at least one first clamping element (11) to interlockingly cooperate with the at least one second clamping element (22), the extruder unit (4) and the injection unit (3) to directly couple to each other by means of the coupling device (30), and the coupling device (30) to provide the contact pressure of the nozzle head (8) on the nozzle support (19).

11. The multi-component injection moulding machine (1) of claim 1, wherein at least one first clamping element (11) and/or at least one second clamping element (22) is wedge-shaped.

12. The multi-component injection moulding machine (1) of claim 1, wherein the extruder unit (4) can be moved into the first position in that the coupling unit (17) can be moved vis-à-vis the rest of the extruder unit (4) by means of a coupling unit drive.

13. The multi-component injection moulding machine (1) of claim 12, wherein the coupling unit (17) is swivel-mounted on the remaining extruder unit (4).

14. The multi-component injection moulding machine (1) of claim 1, wherein the extruder unit (4) has an extruder housing (15), a rotatable extruder screw (16) accommodated in the extruder housing (15) and a drive unit driving the extruder screw (16), wherein the extruder housing (15) can be moved by an extruder actuator.

15. The multi-component injection moulding machine (1) of claim 14, wherein the drive unit is designed as an electromotive drive unit and/or the extruder actuator is designed as an electromotive extruder actuator.

16. The multi-component injection moulding machine (1) of claim 14, wherein the drive unit is designed as a hydromotive drive unit and/or the extruder actuator is designed as a hydraulic extruder actuator.

17. The multi-component injection moulding machine (1) of claim 16, wherein the extruder unit (4) comprises a hydraulic unit, by means of which the hydromotive drive unit and/or the hydraulic extruder actuator can be supplied with pressurized fluid medium.

18. The multi-component injection moulding machine (1) of claim 14, wherein the extruder actuator is designed as a pneumatic extruder actuator.

19. The multi-component injection moulding machine (1) of claim 18, wherein the extruder unit (4) comprises a pneumatic unit, by means of which the pneumatic extruder actuator can be supplied with pressurized fluid medium.

20. The multi-component injection moulding machine (1) of claim 16, wherein the hydraulic extruder actuator and/or the hydromotive motor drive unit can be supplied with pressurized fluid medium from a hydraulic unit, which is not part of the extruder unit (4).

21. The multi-component injection moulding machine (1) of claim 18, wherein the pneumatic extruder actuator can be supplied with a pressurized fluid medium from a pneumatic unit, which is not part of the extruder unit (4).

22. The multi-component injection moulding machine (1) of claim 1, wherein the extruder housing (15) and the injection unit housing (5) are designed in a cylindrical construction.

23. The multi-component injection moulding machine (1) of claim 22, wherein in the first position the longitudinal axis of the cylindrical extruder housing (15) and the longitudinal axis of the cylindrical injection unit housing (5) span a vertical plane.

24. The multi-component injection moulding machine (1) of claim 22, wherein the first position the longitudinal axis of the cylindrical extruder housing (15) and the longitudinal axis of the cylindrical injection unit housing (5) span a horizontal plane.

25. The multi-component injection moulding machine (1) of claim 23, wherein in the first position the longitudinal axis of the cylindrical extruder housing (15) and the longitudinal axis of the cylindrical injection unit housing (5) include an angle of 90°.

26. The multi-component injection moulding machine (1) of claim 23, wherein in the first position the longitudinal axis of the cylindrical extruder housing (15) and the longitudinal axis of the cylindrical injection unit housing (5) include an angle of less than 90°.

27. The multi-component injection moulding machine (1) of claim 1, wherein the extruder unit (4) is mechanically connected to the rest of the multi-component injection moulding machine (1) via a mechanical interface and this is designed as a Euromap interface.

28. The multi-component injection moulding machine (1) of claim 14, wherein the extruder unit (4) communicates with the remaining multi-component injection moulding machine (1) via a signalling interface and this is suitable for transmitting at least three signals, a first signal indicating that the injection unit (3) is in a position corresponding to the first position of the extruder unit (4), a second signal indicating that the extruder unit (4) is in the second position, and a third signal indicating that the extruder unit (4) and the injection unit (3) are both located in the first position and are coupled to each other and the drive unit of the extruder unit (4) drives the extruder screw (16).

29. An extruder unit (4) together with a holding structure (36) for the subsequent upgrading of a one-component injection moulding machine to a multi-component injection moulding machine (1) as claimed in claim 1, comprising an extruder unit (4) with a coupling unit (17) which has at least one second clamping element (22) that mechanically interlocks with at least one first clamping element (11) provided on the injection unit (3) such that in a first position of the extruder unit (4) vis-à-vis the injection unit (3), in which a nozzle support (19) of the extruder unit (4) rests against the nozzle head (8) of the nozzle (7) of the injection unit (3), the injection unit (3) and the extruder unit (4) can be coupled directly to one another by means of a coupling device (30), in that the coupling device (30) provides a contact pressure of the nozzle head (8) on the nozzle support (19), and—a holding structure (35) which is used to connect the extruder unit (4) and can be directly firmly connected to the machine bed (35) or to the injection unit (3), which holding structure allows for adjustably positioning of the extruder unit (4) between the first position and the second position in which the injection unit (3) is released for possible contacting of its nozzle head (8) on a tool clamped on the adjacent mould mounting plate (2).

30. A method for the subsequent upgrading of a single-component injection moulding machine, which single-component injection moulding machine comprises at least two mould mounting plates (2) displaceable relative to each other by means of a closing unit and an injection unit (3) displaceable relative to the adjacent mould mounting plate (2) and having a nozzle (7) with a nozzle head (8), to form a multi-component injection moulding machine as defined in claim 1, the method comprising mounting an extruder unit (4) together with a holding structure (36) by firmly connecting said holding structure (36) directly to the machine bed (35) or the injection unit (3),
wherein the holding structure (36) allows for adjustably positioning of the extruder unit (4) vis-à-vis the injection unit (3) between a first position, in which a nozzle support (19) of the extruder unit (4) rests against the nozzle head (8) of the nozzle (7) of the injection unit (3), and a second position in which the injection unit (3) is released for possible contacting of its nozzle head (8) on a tool clamped on the adjacent mould mounting plate (2),
and wherein moreover the injection unit (3) and the extruder unit (4), in the first position of the latter, can be coupled directly to one another by means of a coupling device (30), in that the coupling device (30) provides a contact pressure of the nozzle head (8) on the nozzle support (19), wherein at least one second clamping element (22) of a coupling unit (17) of the extruder unit (4) mechanically inter-lockingly interacts with at least one first clamping element (11) provided at the injection unit (3).
